(19) United States
(12) Patent Application Publication
(10) Pub. No.: US 2008/0120104 A1
(43) Pub. Date: May 22, 2008

(54) Method of Transmitting End-of-Speech Marks in a Speech Recognition System

(76) Inventor: Alexandre Ferrieux, Pleumeur Bodou (FR)

Correspondence Address: COHEN, PONTANI, LIEBERMAN & PAVANE, 551 FIFTH AVENUE, SUITE 1210, NEW YORK, NY, 10176, US

(21) Appl. No.: 11/883,970

(22) PCT Filed: Dec. 28, 2005
(86) PCT No.: PCT/FR05/03309

§ 371 Date: Aug. 6, 2007

(30) Foreign Application Priority Data
Feb. 4, 2005 (FR) 0550322

(51) Int. Cl. G10L 15/00; G10L 17/00

(52) U.S. Cl. 704/246; 704/E15.002; 704/E17.001

(57) ABSTRACT

A method of transmitting end-of-speech marks in a distributed speech recognition system operating in a discontinuous transmission mode, in which system speech segments (30, 40) are transmitted, followed by periods (34) of silence, each speech segment (30, 40) terminating with an end-of-speech mark (31, 41). The end-of-speech mark (31) is retransmitted continually (31a, 31b, 31c, 31d) throughout the duration of the period of silence (34) following said speech segment (30).

The present invention relates to a method of transmitting end-of-speech marks in a distributed speech recognition system operating in discontinuous transmission mode.

The invention finds a particularly advantageous application in the general field of speech recognition.

More specifically, the context of the invention is that of distributed speech recognition (DSR) as defined in the ETSI standards ES 201 108, ES 202 050, ES 202 212 and the IETF document RFC3557.

As a general rule, speech recognition methods involve a first stage of extracting acoustic parameters from a speech segment spoken by a speaker, who can be the user of a terminal, in particular a mobile telephone. In a second stage, the acoustic parameters obtained are processed by a dedicated speech recognition system to restore the phonetic content of the spoken speech segment. A server incorporating the speech recognition system can then react to what the speaker said, now that it has been restored. This server is a voice server in a mobile telephone system, for example.

Distributed speech recognition (DSR) effects the first stages of speech recognition, i.e. extracting the acoustic parameters, in the terminal itself, and transmits only the result to the server. When these parameters are chosen to optimize speech recognition performance, a clear improvement in speech recognition is obtained at a bit rate equivalent to that of a standard coder/decoder (codec) for conversation between humans.

The document RFC3557 mentioned above describes transmitting the acoustic parameters as the payload of the real time protocol (RTP) of the document RFC3550. One version of DSR proposed in the document RFC3557 relates to discontinuous transmission (DTX) where the terminal sends data to the server only during speech segments, not continually. To this end, data is sent only when the user presses a key of a “Push-to-Talk” device, or under the control of a voice activity detector (VAD). Clearly the benefit of discontinuous transmission is that it economizes on bandwidth during periods of silence.

Of course, if the DTX mode is used, it is necessary for the voice server to know when the speech segments end, for example, in order to be able to indicate to the speech recognition system that all the acoustic parameter data has been received and it may now effect the recognition operations and finalize its result. The document RCF3557 provides for this purpose special data packets containing null frames and serving as end-of-speech marks.

A drawback of the DTX mode is that if packets of null frames are lost in the network during data transmission, the server is no longer informed of the end-of-speech segments, and cannot give any execution instruction to the speech recognition system. As a result of this, the server cannot respond to what the user says, and the user must then suffer long and unacceptable waiting periods.

To remedy this drawback, a time-out mechanism has been proposed that causes the server to react if no end-of-speech segment is received by the end of a given time period. However, that blind type of mechanism is necessarily slow because it is linked to the sometimes long delays of the speech segments in normal conversation.

Thus the technical problem to be solved by the subject matter of the present invention is proposing a method of transmitting end-of-speech marks in a distributed speech recognition system operating in discontinuous mode in which system speech segments are sent followed by periods of silence, each speech segment terminating with an end-of-speech mark, which method should make the signaling channel consisting of the end-of-speech marks more robust than a time-out mechanism when faced with transmission losses, thereby guaranteeing delays linked only to network conditions and not set arbitrarily at necessarily longer time-out periods.

The solution of the present invention to the stated technical problem is that said end-of-speech mark is retransmitted continually throughout the period of silence following said speech segment.

Thus even if a transmission loss occurs at the end of a speech segment, causing the loss of the end-of-speech mark contained in the truncated segment, the end of segment information can nevertheless be communicated to the server as soon as the network becomes operational again, since the server can then receive the end-of-speech mark retransmitted immediately after transmission resumes. The server is therefore able to respond very effectively when notified of the end of a segment, either to instruct the execution of the recognition operation or to reject a segment truncated by line losses.

The timing of the retransmission of the end-of-speech marks, i.e. the duration of the time period between two consecutive retransmitted marks, must allow for the following compromise:
if it is too slow, the user may perceive long latencies, i.e. the same drawbacks as the time-out mechanisms referred to above;
if it is too fast, the bandwidth consumed during periods of silence can approach that of periods of speech, thereby canceling out the benefit of DTX mode discontinuous transmission. Moreover, this speed may be of no utility because of the temporal tolerance of the user and the temporal correlation of the losses of packets whereby two end-of-speech marks retransmitted too close together have a strong chance of being lost at the same time.

Two options are possible: in a first option, said end-of-speech mark is retransmitted at time intervals of the same duration, while in a second option said end-of-speech mark is retransmitted at time intervals of increasing duration. This second option is advantageous in terms of bandwidth, but has the risk of reintroducing long latencies.

According to the invention, a satisfactory compromise is for said duration to be of the order of one second.

In one particular embodiment of the invention, the retransmission of said end-of-speech mark is interrupted on reception of a message acknowledging a retransmitted end-of-speech mark.

This feature has the advantage of economizing on bandwidth and is therefore preferable if the bandwidth available is limited. Otherwise, an acknowledgement from the server is not necessary, the bandwidth consumed being considered tolerable even if the first end-of-speech mark reaches the server, although retransmission of additional end-of-speech marks is then of no utility.

To limit bandwidth consumption further, the invention provides for the end-of-speech mark to be transmitted in packets of length that is less than the nominal length of the pairs of frames in said speech segments.

Finally, another advantage of the invention must be emphasized, one that is particularly important in the event of high transmission losses. If there is considerable interference and noise in the network, total loss of a speech segment may occur. For example, if transmission is restored during the period of silence that follows the lost segment, the voice server could nevertheless receive an end-of-speech mark because of the continual transmission of end-of-speech marks in accordance with the invention. The packets transporting these marks generally comprise an indication of the time of day of the end-of-speech mark of the segment concerned, so that by comparing the times of day of the last two end-of-speech marks successively received, the server can detect the loss of the speech segment and respond to the user appropriately, for example by asking the user to repeat the message.

The present invention also relates to a system for distributed speech recognition operating in discontinuous mode comprising a terminal adapted to send speech segments followed by periods of silence, each speech segment terminating with an end-of-speech mark, which system is noteworthy in that said terminal is adapted to retransmit said end-of-speech mark continually for the duration of the period of silence following said speech segment.

The system of the invention is moreover noteworthy in that it also comprises a voice server adapted to send a message acknowledging a retransmitted end-of-speech mark.

The following description with reference to the appended drawings, which are provided by way of non-limiting example, explains in what the invention consists and how it can be reduced to practice.

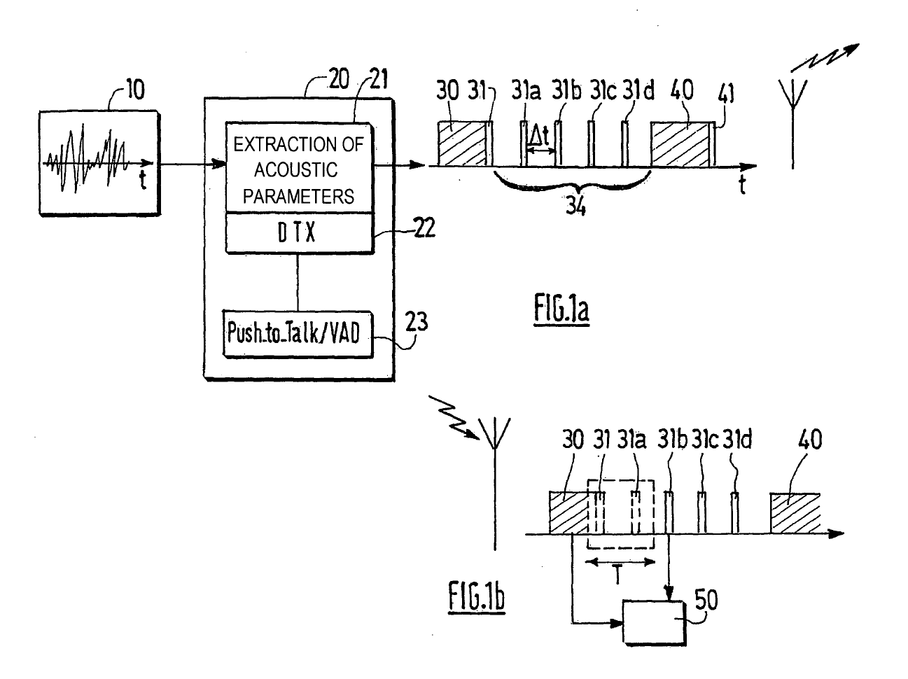

FIG. 1a is a diagram showing the operations effected in a terminal using the method of the invention.

FIG. 1b is a diagram showing the operations effected in a voice recognition server associated with the FIG. 1a terminal.

FIG. 1a shows the various successive operations effected in a terminal, for example a mobile telephone, in the general context of a distributed speech recognition system in which messages spoken into the terminal by the user must be identified by a voice server shown in FIG. 1b.

According to FIG. 1a, the voice message sent by the user is processed in the terminal itself, in accordance with the distributed speech recognition (DSR) procedure. This processing is therefore effected in a unit 20 of the terminal including a module 21 for extracting from the voiced signal 10 the acoustic parameters needed by the voice recognition system of the server to reconstitute the message spoken by the user. Methods for extracting acoustic parameters are well known and outside the scope of the present invention. The corresponding ETSI standards ES 201 108, ES 202 050, ES 202 212 may be referred to.

As FIG. 1a indicates, the operation of extracting acoustic parameters is complemented by the use of a discontinuous transmission (DTX) mode by a module 22 of the processor unit 20 with the aim of restricting sending of data to the server to the speech segments alone. To this end, the module 22 receives from an indicator 23 a start-of-speech signal. Said indicator 23 can be a “Push-to-Talk” device where the user presses a key on beginning to speak or a voice activity detector (VAD).

The signal supplied by the processor unit 20 of the terminal therefore consists of speech segments 30, 40 comprising packets transporting in their payload the acoustic parameters extracted by the module 21. Each speech segment terminates with an end-of-speech mark 31, 41. The two consecutive speech segments 30 and 40 are separated by a period 34 of silence.

It can be seen in FIG. 1a that the speech mark 31 associated with the segment 30 is retransmitted continually throughout the duration of the period 34 of silence following said segment. The retransmitted end-of-speech marks are denoted 31a, 31b, etc.

The benefit of this becomes clear in FIG. 1b, which shows a speech recognition system 50 of a voice server.

The signal containing the acoustic parameters of the user is transmitted over the network to the system 50, which reconstitutes the voice message spoken by the user from the data received in the speech segments 30, 40. The end-of-speech mark 31 indicates to the system 50 that the end of the segment 30 has been reached and that it may now effect the recognition operation for that segment.

If transmission across the network were to be disrupted during a period T, as indicated in FIG. 1b, thereby truncating the end of the segment 30 and, for example, the end-of-speech marks 31 and 31a, the mark 31b immediately after transmission resumes would be detected by the system 50. The recognition operation could then be effected precociously, the delay introduced being of the order of the duration of the network losses, and therefore definitely shorter than achieved by the time-out mechanisms usually employed.

In FIGS. 1a and 1b, said end-of-speech mark 31 is retransmitted at time intervals of the same duration Δt, for example of the order of one second. However, having the duration of the time intervals between two consecutive retransmissions increase, for example by a factor of 1.5 or 2, may equally be envisaged.

As already indicated above, the sending of the end-of-speech marks 31, 31a, etc. can be interrupted on reception by the terminal of a message acknowledging reception by the server of an end-of-speech mark. Accordingly, in the example of FIGS. 1a and 1b, after receiving the mark 31b, the server can send the terminal a message acknowledging reception of that mark. Informed of this, the terminal can interrupt the sending of new end-of-speech marks 31c, 31d, etc. that are now of no utility.

Finally, bandwidth can be saved by limiting the packets transporting the end-of-speech marks 31a, 31b, etc. to the necessary minimum, so that their length is significantly less than the nominal length of the pairs of frames in the speech segments.

1. A method of transmitting end-of-speech marks in a distributed speech recognition system adapted to operate in a discontinuous transmission mode in which speech segments (30, 40) are transmitted followed by periods (34) of silence and each speech segment (30, 40) terminates with an end-of-speech mark (31, 41), wherein said end-of-speech mark (31) is retransmitted continually (31a, 31b, 31c, 31d) for the duration of the period of silence (34) following said speech segment (30).

2. A The method according to claim 1, wherein said end-of-speech mark (31) is retransmitted at time intervals of the same duration (Δt).

3. The method according to claim 1, wherein said end-of-speech mark is retransmitted at time intervals of increasing duration (Δt).

4. The method according to claim 2, wherein said duration (Δt) is of the order of one second.

5. The method according to claim 1, wherein the retransmission of said end-of-speech mark (31) is interrupted on reception of a message acknowledging a retransmitted end-of-speech mark (31b).

6. The method according to claim 1, wherein the end-of-speech marks (31a, 31 b, 31c, 31d) are transmitted in packets shorter than the nominal lengths of pairs of frames in said speech segments (30, 40).

7. A distributed speech recognition system adapted to operate in a discontinuous mode and comprising a terminal adapted to send speech segments (30, 40) followed by periods (34) of silence, each speech segment (30, 40) terminating with an end-of-speech mark (31), wherein said terminal is adapted to retransmit said end-of-speech mark (31) continually (31a, 31b, 31c, 31d) for the duration of the period (34) of silence following said speech segment (30).

8. The system according to claim 7, further comprising a voice server adapted to send a message acknowledging a retransmitted end-of-speech mark (31b).

9. A terminal of a distributed speech recognition system adapted to operate in discontinuous transmission mode, said terminal being adapted to send speech segments (30, 40), followed by periods (34) of silence, each speech segment (30, 40) terminating with an end-of-speech mark (31), wherein said terminal is adapted to retransmit said end-of-speech mark (31) continually (31a, 31b, 31c, 31d) for the duration of the period (34) of silence following said speech segment (30).
